(19) United States
(12) Patent Application Publication
(10) Pub. No.: US 2003/0086122 A1
(43) Pub. Date: May 8, 2003

(54) Imaging device communication via email

(76) Inventor: Travis J. Parry, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/011,539

(22) Filed: Nov. 6, 2001

(51) Int. Cl. H04N 1/00

(52) U.S. Cl. 358/402

(57) ABSTRACT

An improved class of imaging devices with an ability to communicate via electronic mail (Email) is described. The improved imaging devices present a simple single protocol and interface that has the added benefit of being available in most network environments. Email protocol is also generally routed over firewalls, routers, bridges, and virtual private networks and does not require constant upgrades of management programs or drivers to maintain. Additionally, “master” imaging devices may be configured to manage other slave imaging devices on the network providing a single interface to imaging device management. These master devices can also provide Email to protocol translation for devices that are not Email compatible.

### TECHNICAL FIELD OF THE INVENTION

The present invention relates generally to imaging device communication and in particular the present invention relates to imaging device communication and management via Email.

### BACKGROUND OF THE INVENTION

Computing devices are typically coupled to networks in modern computing environments. Networks in this definition include fiber optic, wire, wireless, and virtual, such as a virtual private network (VPN). In particular, imaging devices, such as printer, projectors, displays, and scanners are typically networked in modern computing environments. These imaging devices are typically set up and configured with a built in user interface or are configured remotely over the network. Imaging devices in organizations are typically implemented as networked imaging service providers in computer networks. In this disclosure imaging devices are intended to include, but are not limited to, printers, multi-function copiers, digital projectors, terminals, and other such imaging devices.

When being configured over the network, the imaging devices generally require a specialized management facility, program, or protocol to interface with. These specialized management facilities, programs, or protocols are generally referred to herein as management facilities. The management facilities are typically specific to the device, class of device, or even device manufacturer, that is being managed or communicated to. This narrowness of use with existing management facilities can cause issues with ease of management of the imaging devices. In addition, in many situations, network features such as firewalls or routers interfere with the management facilities being utilized. The result being that some or all of the imaging devices being managed are unreachable across the network with the management facility.

In addition, the management facilities often differ in interface and function and thus require the user/administrator to remember the particulars of operating the management facilities and configuring the imaging devices through them. Oftentimes this requires the user/administrator to have training in the operation of the management program of the imaging device being managed. The management facilities are also often updated or changed as new features and capabilities are introduced to the devices and/or the management facilities themselves. Thus, with multiple management facilities, managing and communicating with these imaging devices is difficult, time consuming, and inconvenient for the network administrator and users.

Many imaging devices gather usage information and statistics on their use and operation within the network, allow for online changing of configuration parameters, and upgrade of firmware or software. Some of the commonly used settings and gathered usage information includes job origin, number of pages printed or imaged, resolution, mode, duplex, economy and performance settings, number of copies of jobs received, number of errors, types of errors, marking material usage (such as ink, toner, thermal material, etc.), marking material level, consumables (such as paper, transparency, etc.) type and usage, and other usage information or statistics. However, many other types of settings, usage information, and statistics can and are gathered in imaging systems.

Many of these imaging devices are configured with options specific to the device, its location, or its purpose. Imaging devices on a network can and typically are of many device types, brands, and models. However, organizational and network wide common device configurations, where a baseline configuration is established across all devices or a class of devices, are a standard practice. Particularly among imaging devices of a similar type, model, or manufacturer.

FIG. 1 details a simplified diagram of a network and imaging device system as background. FIG. 1 includes a local network backplane 100, a router/bridge 102, firewalls 104, a remote network backplane 106, local imaging devices 108, a server 112, a workstation 114, a management facility 116, and a remote imaging device 118. Each local and remote imaging device 108, 118 is coupled to the network 100, 106 with a network interface (not shown). Each local and remote imaging device 108, 118 also contains device configuration information, device firmware/software, and gathers it own usage information and statistics, which can include such information as number of pages imaged, number of jobs received, number of copies of jobs received, and numbers of errors. The management facility 116 allows management and querying of the local and remote imaging devices 108, 118 across the network. Each local imaging device 108 communicates to the management facility 116 across the local network backplane 100, and router/bridge 102, if necessary. Each remote imaging device 118 communicates to the management facility 116 across the remote network backplane 106, firewalls 104, and local network backplane 100. The management facility 116 may be a function of a network device, such as a master imaging device, server, workstation or other similar device. The management facility 116 is generally a software program running on some platform or operating system, but such functionality could be expressed in firmware or even hard-coded in a device such as an application-specific integrated circuit (ASIC) chip. In general, however, the management facility 116 includes a set of computer-readable instructions stored on a computer-usable medium for execution by a processor. Examples of computer-usable medium include removable and non-removable magnetic media, optical media, dynamic random-access memory (DRAM), static random-access memory (SRAM), read-only memory (ROM) and electrically-erasable and programmable read-only memory (EEPROM or Flash).

For the reasons stated above, and for other reasons stated below which will become apparent to those skilled in the art upon reading and understanding the present specification, there is a need in the art for a method of conveniently communicating to and managing imaging devices in a network environment.

### SUMMARY OF THE INVENTION

The above-mentioned problems with organizing, communicating with, and managing imaging devices that have multiple specialized management facilities, programs, or protocols are addressed by the present invention and will be understood by reading and studying the following specification.

In one embodiment, an imaging device comprises a network interface, and an Email processing system, wherein the Email processing system of the imaging device can communicate via Email through the network interface and where the Email processing system is adapted to process Email messages that are selected from the group consisting of a configuration update, a data request, and an imaging device command.

In another embodiment a computer usable medium has computer readable instructions stored thereon for execution by a processor to perform a method. The method comprises receiving an Email message at an imaging device, and processing the Email message on the imaging device, wherein the Email message is selected from the group consisting of a configuration update, a data request, and an imaging device command.

In a method of operating an imaging device, the method comprises receiving an Email message at an imaging device, and processing the Email message on the imaging device, wherein the Email message is selected from the group consisting of a configuration update, a data request, and an imaging device command.

In another method of operating an imaging device system having a plurality of imaging devices, the method comprises composing an Email message, sending an Email message to at least one imaging device of the plurality of imaging devices, relaying the Email message through a relay device to a receiving imaging device, and interpreting the Email message on the at least one imaging device, wherein the Email message is selected from the group consisting of a configuration update, a data request, and an imaging device command.

In yet a further embodiment, a system comprises at least one relay device, and a plurality of imaging devices. The at least one imaging device of the plurality of imaging devices includes a network interface, and an Email processing system, wherein the Email processing system of the imaging device can communicate via Email through the network interface to the at least one relay device, and where the Email processing system is adapted to process Email messages that are selected from the group consisting of a configuration update, a data request, and an imaging device command.

### BRIEF DESCRIPTION OF THE DRAWINGS

FIG. 1 is a simplified diagram of a network with imaging devices, routers/bridges, remote networks, firewalls, and management facility.

FIGS. 2A and 2B are simplified diagrams of individual Email message exchange protocols.

FIGS. 3A and 3B are simplified diagrams of general Email message routing architectures with embodiments of the present invention.

FIG. 4 is a simplified diagram of User/Admin/Program to Master Device to Slave Devices Email messaging architecture with embodiments of the present invention.

FIG. 5 is a simplified diagram of User/Admin/Program to Master Device to Local Master Devices to Slave Devices Email messaging architecture wherein the Slave Devices are not Email capable and located behind network obstacles.

FIGS. 6A, 6B, and 6C are flow charts of differing Email messaging origination procedures.

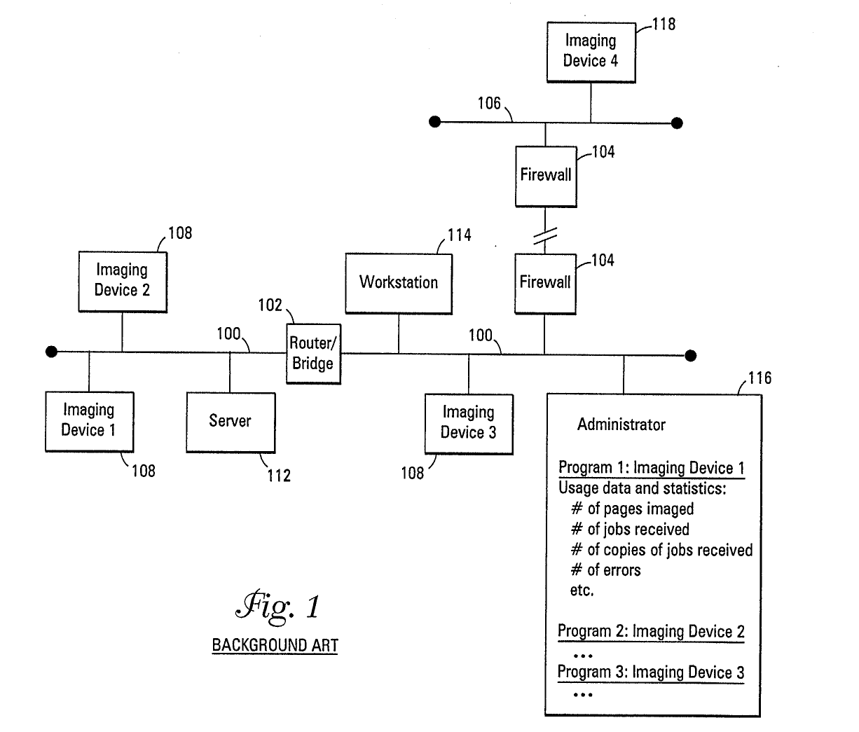

### DETAILED DESCRIPTION OF THE INVENTION

In the following detailed description of the preferred embodiments, reference is made to the accompanying drawings that form a part hereof, and in which is shown by way of illustration specific preferred embodiments in which the inventions may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense, and the scope of the present invention is defined only by the claims.

Embodiments of the present invention include imaging devices that send and process inter-device messages, jobs, information, configuration changes and updates via electronic mail (Email) and embedded Email processing systems to other Email capable imaging devices, workstations, servers, network devices, or administrators/users. This allows these imaging devices to be configured over a network with a common non-device specific interface and protocol, without the need to have a special purpose device management program or user interface.

Specific embodiments of the present invention include, but are not limited to, imaging devices that can send or receive Email messages that contain configuration information, firmware/software, actions/directives, errors, alerts, device information, requests for actions, requests for service, requests for further guidance, requests for consumables, imaging jobs, imaging job information, and supplemental information and data.

With a common Email interface and protocol the need for training and support of multiple specialized management facilities, programs, or protocols is minimized. The common Email interface and protocol also allow a single specific device, class of device, or even class of device manufacturer to be managed or communicated to either singly or as a group. In addition, most network features, such as firewalls or routers, route or will not interfere with Email protocol. This allows all of the imaging devices to be communicated with or managed, even at remote sites.

There are many types of Email protocols and transport mechanisms. Email protocols range from “simple mail transfer protocol” (SMTP) to MICROSOFT EXCHANGE SERVER™ mail protocol. However, Email protocols generally involve transferring encoded text messages across networks to remote recipients, with many protocols providing for attachment of documents and binary files. As stated above, most Email protocols are generally routed through firewalls, routers, and other network features, or have an easily configured method of routing. This routing of Email protocols is commonly available even where hypertext transfer protocol (HTTP), another routed protocol that is highly likely to be allowed through filtering network features, is not permitted.

Email messaging, like many communication protocols, has a base level that allows for unidirectional (a one directional message) or bi-directional (an initiating message followed by a reply message or acknowledge) message transactions. Additionally, broadcast (one to many) and individual (one to one) Email addressing is available that allows an efficiency in communications for single and bulk messages. This allows for multiple device and communication architectures (user to device, device to user, user to many devices, device to device, device to many devices, user to master device, master device to slave device, user to master device to one or many slave devices, master device to local master device, etc.) to be utilized by the Email messaging of embodiments of the present invention. Email messages can be also be triggered or initiated by multiple means (manual, polling, or event driven) in embodiments of the present invention.

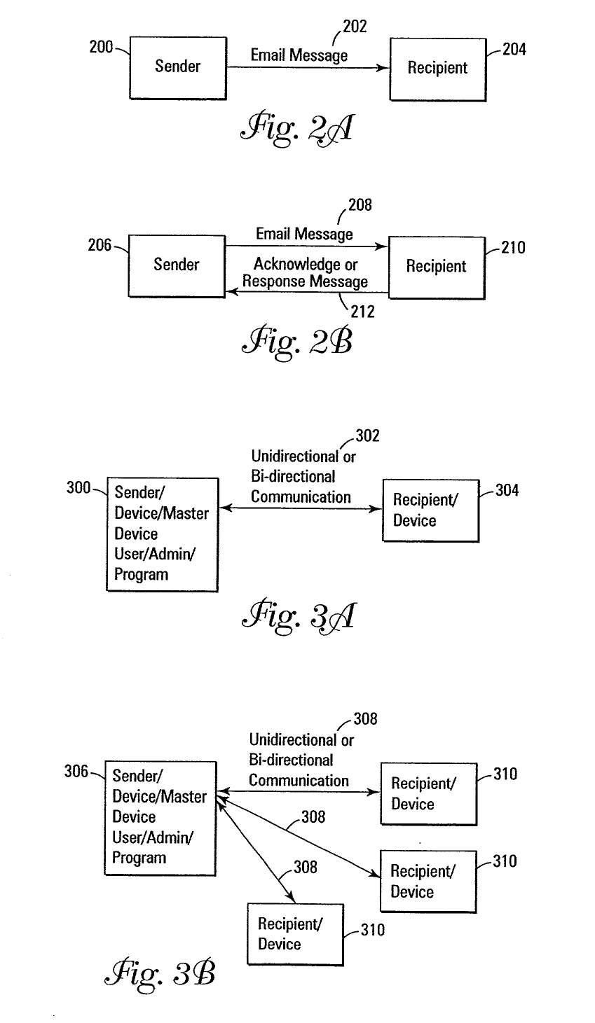

In a basic form, an Email communication with an imaging device of the present invention comprises a basic computer communication protocol. An example of a base form of an Email message in an embodiment of the present invention is a single unidirectional data message or “datagram” that is sent to or from the imaging device. In this context, a unidirectional message, regardless of content, is one where the sender or sending device does not expect a confirmation or reply. An example of a unidirectional communication exchange is detailed in FIG. 2A. In FIG. 2A, a sender or sending device 200 transmits an Email message 202 to a recipient or receiving device 204. No response message is sent by the recipient or receiving device 204 or is expected by the sender or sending device 200.

A more complex example of a base Email communication form is a bi-directional message and response, also known as a request/acknowledge or datagram/acknowledge, wherein an Email message is dispatched by the sender or sending device to a recipient or receiving device and an acknowledge Email is expected by the sender or sending device to confirm receipt of the initial message. The dispatch of the acknowledge Email can be immediate, to acknowledge receipt of the message, or alternatively, be delayed until a requested action has been accomplished to allow for confirmation of the event or action. The acknowledge Email message itself can either be a message with little or no content, which merely acknowledges the initial message, or a fully formed message with content that is a response to the original sender or sending device. An example of a bi-directional communication exchange is detailed in FIG. 2B. In FIG. 2B, a sender or sending device 206 transmits an Email message 208 to a recipient or receiving device 210. A response message or acknowledge 212 is sent by the recipient or receiving device 210 and is expected by the sender or sending device 206 to confirm transmission and/or contain response information.

Additionally, Email messages in embodiments of the present invention can also be sent to a single imaging device, or as a broadcast to multiple devices. In FIG. 3A, an example of a single device communication is shown. A unidirectional or bi-directional Email message 302 is sent by sender or sending device 300 to a single recipient or receiving device 304. In FIG. 3B, an example of a broadcast communication is shown. A unidirectional or bi-directional Email message 308 is sent by sender or sending device 306 to multiple recipient or receiving devices 310.

Email message content in embodiments of the present invention range from simple text to formatted binary code or documents. Email communications to, from, or between embodiments of the present invention include, but are not limited to, simple text, extensible markup language/hypertext markup language (XML/HTML), encoded binary, numeric code, device specific command code, or other. This range of message content enables the use of formatted messages or forms, in particular XML/HTML formats and forms, to ease device communication and management by human operators or administrators. As stated above, the use of standard Email messages also allows for attachments and encoding of special elements within the Email body if desired.

As previously stated, specific embodiments of the present invention include, but are not limited to, imaging devices that can send or receive Email messages that contain configuration information, firmware/software, actions/directives, errors, alerts, device information, requests for actions, requests for service, requests for further guidance, requests for consumables, imaging jobs, imaging job information, and supplemental information and data.

Email message contents and actions in embodiments of the present invention, include, but are not limited to, status, usage data, configuration parameters, firmware/software updates, or references to firmware/software updates, print or imaging jobs, imaging device commands, imaging device capability reports, suggested Email message forms and formats, and encoded attachments in binary or other form.

Imaging device embodiments of the present invention may send or receive Email messages containing general information, print or imaging jobs, action request, data delivery, or any other information necessary to operate or process. Queries or information requests may also be received and responded to from the device. Response Email messages may contain status, usage data, configuration parameters, imaging device commands, or any such information as the imaging device may have requested of it.

Email directives can be sent to a “master” device which distributes all additionally necessary Emails to other known imaging devices from an internally kept address list or an address list that is attached to the original Email message it received. Alternatively, Email directives can be sent directly to some or all managed imaging devices directly by an administrator.

Specific embodiments of the present invention can receive Email messages that contain information and specific commands to process imaging jobs and job information. These imaging jobs and job information include, but are not limited to, imaging jobs and data, job copies, job transfers, and job specific commands or configurations, such as, job status, job pause, job resume, delete job, duplex job, staple the job, high quality mode for job, economize mode for job, dither job, etc.

An example of one of the features such an Email ability can allow for is the ability of an imaging device to transfer an imaging job to another imaging device in accordance with an embodiment of the present invention by Emailing the device the job request or simply forwarding the original Email containing the job in question. For one embodiment, the receiving device sends an acknowledgement to the originating or requesting device.

Specific embodiments of the present invention can also receive Email messages that contain information and specific commands to process action requests and directives to the imaging device. Such action requests and directives include, but are not limited to, device reset, device restart, device power down, device offline/online, device to power save mode, device status report/update, etc.

Specific embodiments of the present invention can send Email messages that contain information and specific requests about device or processing errors and device alerts. Such information and specific requests about device or processing errors and device alerts include, but are not limited to, job processing errors, media jams, media or consumables out/low, out of paper alerts, requests for guidance or additional information on an error, Email suggested handling or re-routing of a job, etc.

Specific embodiments of the present invention can additionally receive Email messages that contain information and specific commands to process configuration parameters and information. These configuration parameters and information include, but are not limited to, full or partial configuration updates or changes, and firmware or software updates. Such Email messages can apply a configuration to a single device or to multiple imaging devices, allowing for the setting of global site configurations. Alternatively, only a selected subset, type, or manufacture of devices of those present on the network can be selected to be configured. In addition a “mask” can be applied to a configuration parameter update to allow only selected parameters to be changed, keeping the device-specific parameters unchanged. These changes can be Emailed globally to all managed devices (for example to set a baseline configuration), to a selected set of imaging devices, or to a specific imaging device. For firmware or software upgrades, an Email message containing a device software or firmware update can be sent to an imaging device embodiment of the present invention to allow or direct the device to upgrade.

The specific device update configuration parameters, software, or firmware can be contained in the Email message, as an attachment or an encoding for example. Or, alternatively, a reference to where the update can be found can be sent. The reference in this situation would comprise a location on the local network or on a remote network and what protocols and access keys are necessary to access it.

Specific embodiments of the present invention can additionally receive Email messages that contain requests for generic device information or device usage information and statistics. This generic device information or device usage information and statistics include, imaging device capabilities, settings and gathered usage information such as job origin, number of pages printed or imaged, resolution, mode, duplex, economy and performance settings, number of copies of jobs received, number of errors, types of errors, marking material usage (such as ink, toner, thermal material, etc.), marking material level, consumables (such as paper, transparency, etc.) type and usage, and other usage information or statistics.

Specific embodiments of the present invention can send Email messages that contain specific requests and information about a device. Such information and specific requests from the imaging device include, but are not limited to, requests by the device for specific actions by the administrator/specific user/program/driver, requests by the device for service or maintenance, requests by the device for further guidance/input, requests by the device for additional consumables. Device information that can be sent includes device configuration information, firmware/software, and all generic device information or device usage information.

Additionally, supplemental information and data can be sent or received by specific embodiments of the present invention. Such supplemental information and data includes, but is not limited to, imaging device Email distribution lists, supplemental device parameters, network time, example Emails and forms, manuals, software, etc.

An example of such supplemental information and data sending and receiving are imaging device embodiments of the present invention configured to respond to Email messages requesting operation or help information with example Email messages, codes, forms in text/XML/HTML, or even electronic versions of device manuals to an Email message requesting the information. This feature, if implemented in a device, would allow an imaging device of the present invention to act as a repository of information, manuals, drivers, and code that enables its own communication and management.

It is noted that alternative manners of Email message content and actions of imaging devices in accordance with embodiments of the present invention are possible and should be apparent to those skilled in the art with the benefit of the present disclosure.

In embodiments of the present invention Email messages may come from single points of origination and have single or multiple destinations, as stated above. The full range of Email content capable in conventional person-to-person communication with Email messaging is possible. This leads to multiple possible network configurations and management architectures for imaging device embodiments. Examples of these architectures include, but are not limited to, imaging device-to-imaging device, user/administrator/program-to-device, device-to-user/administrator/program, user/administrator/program-to-master device, and master device-to-slave device(s).

In device-to-device communication, Email messages containing requests, information, data, and/or configuration updates are passed with an electronic mail protocol directly from one device to another device. Alternatively, Email messages can also be passed from one device to multiple devices in a broadcast that can include some or all devices being managed on the network. An example of a single device communication can be shown with reference to FIG. 3A. In a single device communication, a unidirectional or bi-directional Email message 302 is sent by a sender 300 to a single receiver 304. The sender 300 in this example is a first imaging device and the receiver is a single second imaging device. An example of a multiple device broadcast communication can be shown with reference to FIG. 3B. In a multiple device broadcast communication, a unidirectional or bi-directional Email message 308 is sent by a sender 306 to receivers 310. The sender 306 in this example is a first imaging device and the receivers are multiple second imaging devices.

In user/administrator/program-to-device communication, Email messages containing requests, information, data, and/or configuration updates are passed with an electronic mail protocol directly from the individual user/administrator/program to one or more devices. In device-to-user/administrator/program communication, Email messages containing requests, information, and/or data are passed with an electronic mail protocol directly from a device to a user/administrator/program, e.g., if the device is responding, error alerting, or requesting further guidance.

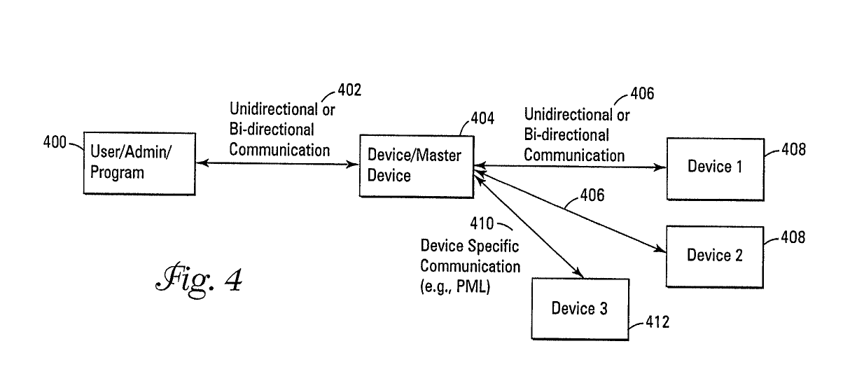

User/administrator/program-to-master device communication is similar to user/administrator/program-to-device communication in that Email messages containing requests, information, data, and/or configuration updates are passed with an electronic mail protocol directly from a user/administrator/program to a master device. However, unlike user/administrator/program-to-device communication, messages can be passed on from the master device to one or more slave devices. The passed on messages can contain the same requests, information, data, and/or configuration updates as the user/administrator/program-to-master device Email communication. The list of other devices to message can be held internally in the master device, or attached to the original Email message to the master device. In this manner, a larger set of devices can be managed by managing a single device. Actions can be sent to the master device with instructions to duplicate the action on some or all managed slave devices. In addition, spontaneous device-to-device communication can occur between the master device and all managed slave devices. In FIG. 4, an example of a user/administrator/program-to-master device-to-slave device(s) communication is shown. A unidirectional or bi-directional Email message 402 is sent by a user/administrator/program 400 to a master device 404. The master device 404 then relays or composes a unidirectional or bi-directional Email message 406 to a single slave device 408 or to a selected set of slave devices 408. The master device 404 is in effect acting as a relay device for the communication.

If the managed slave device comprises an Email enabled embodiment of the present invention, the message can occur in the same Email message format as the user/administrator/program-to-master device Email communication. If the slave device is not Email enabled, as an additional feature, the master device embodiments of the present invention can optionally act as a translator, transforming the Email message to an appropriate communication protocol such as management language (PML), transmission control protocol/internet protocol (TCP/IP), or other protocol to allow management and communication to the non-enabled device. In such a manner, other imaging devices that are older, of differing type, of differing manufacture, or simply incompatible can be managed with embodiments of the present invention. In FIG. 4, an example of a user/administrator/program-to-master device-to-slave device(s) communication with translation is also shown. A unidirectional or bi-directional Email message 402 is sent by a user/administrator/program 400 to a master device 404. The master device 404 then relays or translates and composes a message 410 to the single slave device 412 or to a selected set of slave devices 412 in the appropriate communication protocol for the slave devices 412.

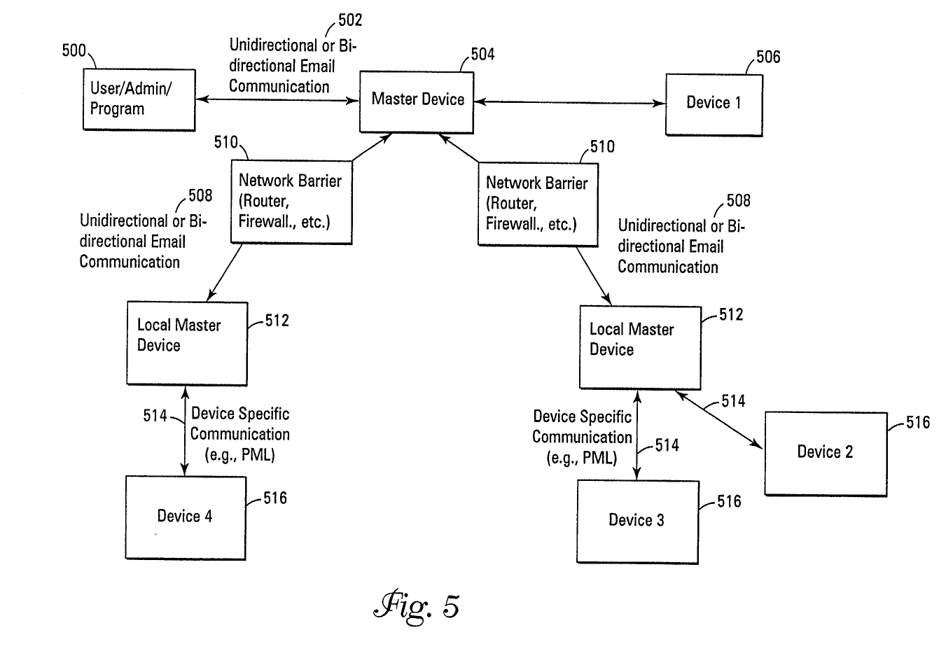

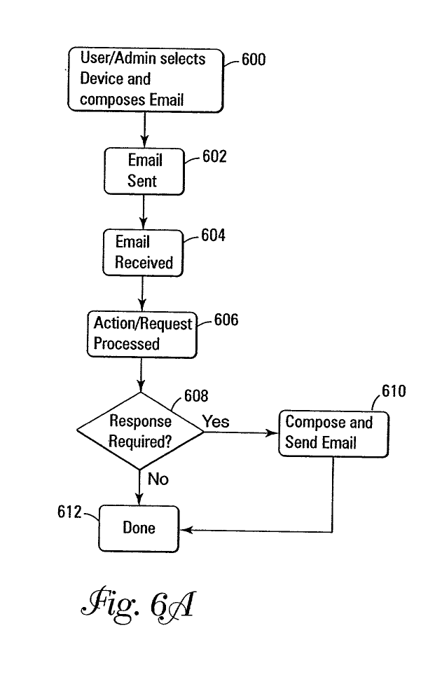

If imaging devices that do not contain embodiments of the present invention are dispersed and/or located behind network obstacles, such as a router, firewall, VPN, or bridge that does not pass the management or network protocol it utilizes, the placement of an imaging device with an embodiment of the present invention to act as a local master device on the local network containing the device(s) will allow communication to, and management of, these devices. The local master devices in turn can be slave devices of a global master to allow for hierarchical device communication and management. In FIG. 5, an example of a user/administrator/program-to-master device-to-local master-to-slave device(s) communication is shown. A unidirectional or bi-directional Email message 502 is sent by a user/administrator/program 500 to a master device 504, which may have local slave devices 506 of its own. The master device 504 then relays or composes a unidirectional or bi-directional Email message 508 in the appropriate communication protocol through a possible network barrier(s) 510 to a local master device 512 or to a selected set of local master devices 512. The local master devices 512 then relays or composes a message 514 in the appropriate communication protocol to a single slave device 516 or to a selected set of slave devices 516 on the local network.

It is noted that alternative manners of Email messaging protocol, content, encoding, and device architecture of imaging devices in accordance with embodiments of the present invention are possible and should be apparent to those skilled in the art with the benefit of the present disclosure.

The method of Email messaging origination or triggering in imaging device embodiments of the present invention or devices, or programs that communicate with them can have multiple implementations. Generally speaking though, Email messaging origination or triggering from imaging device embodiments of the present invention includes but is not limited to, a manually triggered process, a polling process, a chronological process, or an event driven process.

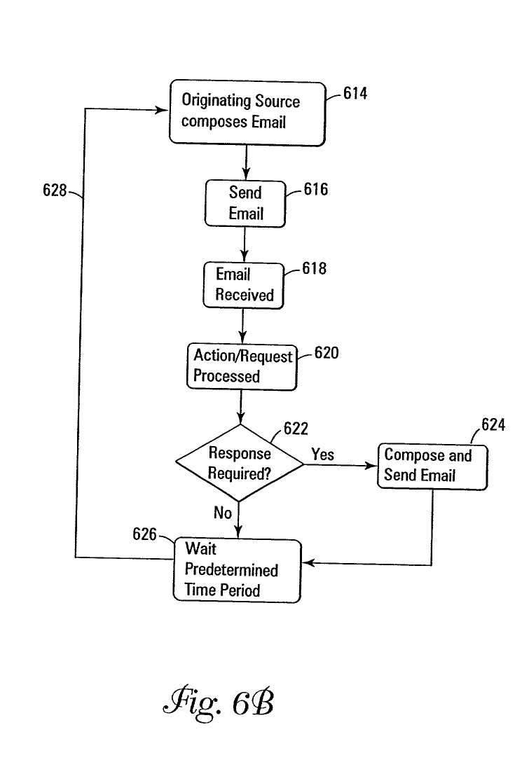

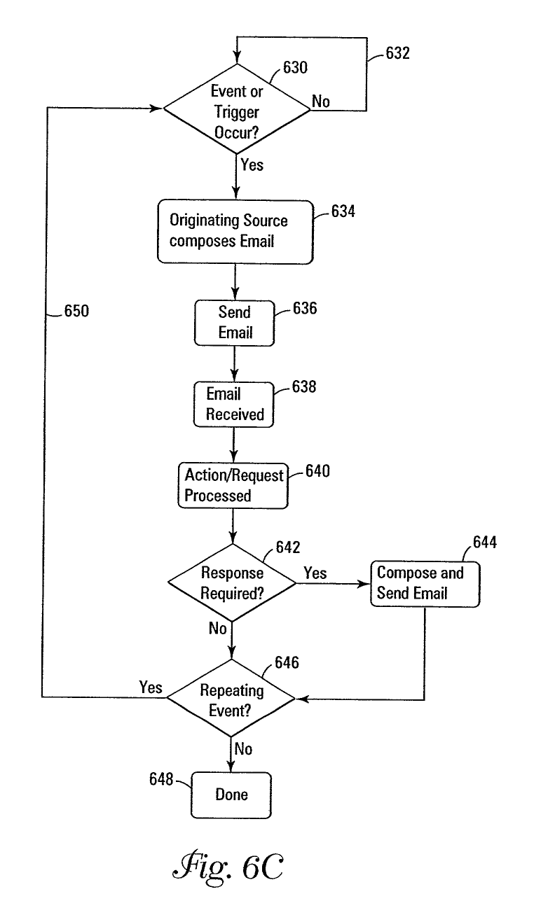

In a manually-triggered Email messaging process, the Email message is manually triggered or sent by the user/administrator/program. The request, information, data, and/or configuration update contained in the Email message is therefore sent to the selected imaging devices by the user/administrator/program as desired. The flowchart shown in FIG. 6A details a simplified manually-triggered Email event. In FIG. 6A, a user/administrator/program selects 600 the imaging device to be communicated with and composes an Email message. The selected imaging device is sent an Email message 602 that contains a request, information, data, and/or configuration update. The selected imaging device receives the Email message 604 and processes the action or request 606. The message type is checked to see if a response is required 608 and a response message or acknowledge message is composed and returned to the user/administrator/program 610, if necessary. The manually-triggered Email messaging process is then done 612 and ready for the next interaction.

In a polled Email messaging process, Email messages are sent that contain a request, information, data, and/or configuration update that must be sent or gathered on a periodic basis to or from a single or multiple imaging devices in accordance with embodiments of the present invention. The origination of the polling Email messages can either be a master device, a user/Email program, or an imaging device control program or driver. Alternatively an individual imaging device can be set to poll a master device, an administrator, or an imaging device control program or driver for information, such as print or imaging jobs, updated configuration, etc. The flowchart shown in FIG. 6B details a simplified polled Email messaging process. In FIG. 6B, the originating source, which is either a device, a master device, a user/Email program, or an imaging device control program or driver, composes 614 and sends 616 an Email message with the request, information, data, and/or configuration update to the recipient. The recipient, which then receives 618 the Email message, can either be a receiving device(s), master device, user/Email program, or imaging device control program or driver. The requested action or request contained in the Email message is then processed 620 by the receiving device. The Email message is checked to see if a response is necessary 622 and a response Email message or acknowledge is composed and sent 624, if required. The polled Email messaging process then waits 626 a predetermined time interval and the process loops and repeats 628.

In an event-driven process, Email messages are sent that contain a request, information, data, and/or configuration update that must be sent or gathered when triggered by an event. This event is typically triggered when some predefined occurrence, such as, a job, an interrupt is received, a time period elapses, a chronological time occurs, a maintenance event occurs, an error occurs, or an action occurs that requires an Email message be sent. The event typically occurs at either an imaging device, a master device, a user/Email program, or an imaging device control program or driver. The flowchart shown in FIG. 6C details a simplified event triggered Email messaging process. In FIG. 6C, the imaging device, master device, user/Email program, or imaging device control program or driver internally loops 632 waiting for an event 630. While it is looping other tasks can optionally be handled if necessary. When an event occurs 630, the required Email message is composed 634 and sent 636 to the appropriate imaging device(s), a master device, user/Email program, or imaging device control program or driver. The recipient, which then receives 638 the Email message, can either be a receiving device(s), master device, user/Email program, or imaging device control program or driver. The requested action or request contained in the Email message is then processed 640 by the receiving device. The Email message is checked to see if a response is necessary 642 and a response Email message or acknowledge is composed and sent 644, if required. The event driven process can be a one-time event or a repeating event that repeats a predetermined number of times or until stopped. If the event-driven process is a repeating event 646, the process loops and repeats 650, returning to waiting for the next event 630. If the event-driven process is not a repeating event 646, the process completes 648.

It is noted that alternative manners of message origination and triggering of imaging devices in accordance with embodiments of the present invention are possible and should be apparent to those skilled in the art with the benefit of the present disclosure.

### Conclusion

An improved class of imaging devices with an ability to communicate via electronic mail (Email) is described. Many networks and administrative systems allow querying and control of networked imaging devices across the network by users and/or management software. However, it has been difficult to organize, control, and manage disparate imaging devices on a convenient network-wide basis where the devices are often of differing types or manufacture or that utilize differing communication protocols. It is particularly difficult when the imaging devices span across network separations that may filter the network traffic and content, such as firewalls, routers, bridges, and virtual private networks (VPN). Additionally, the disparate imaging devices are frequently managed by differing drivers or management programs that change on a regular basis, therefore requiring a user-intensive process to remain current with their use. The improved imaging devices, with an ability to communicate via Email, present a simple single protocol and interface that has the added benefit of being available in most network environments. This protocol is also generally routed over firewalls, routers, bridges, and virtual private networks and does not require constant upgrades of management programs or drivers to maintain. Additionally, “master” imaging devices may be configured to manage other slave imaging devices on the network providing a single interface to imaging device management. These master devices can also provide Email to protocol translation for devices that are not Email compatible.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. An imaging device comprising:
a network interface; and
an Email processing system, wherein the Email processing system of the imaging device can communicate via Email through the network interface and where the Email processing system is adapted to process Email messages that are selected from the group consisting of a configuration update, a data request, and an imaging device command.

2. The imaging device of claim 1, wherein the configuration update is selected from the group consisting of:
a configuration parameter upgrade, a configuration parameter change, a firmware upgrade, a software upgrade, and supplemental data upgrade.

3. The imaging device of claim 1, wherein the imaging device command is selected from the group consisting of:
job processing commands, and imaging device action requests.

4. The imaging device of claim 1, wherein the data request is selected from the group consisting of:
usage information, status information, device information, device capability inquiries, device configuration parameters, device firmware, device supplemental data, example forms, XML data, HTML data, text data, text forms, binary data, encoded binary data, and Email attachments.

5. A computer usable medium having computer readable instructions stored thereon for execution by a processor to perform a method comprising:
receiving an Email message at an imaging device; and
processing the Email message on the imaging device, wherein the Email message is selected from the group consisting of a configuration update, a data request, and an imaging device command.

6. The computer usable medium of claim 5, wherein the configuration update is selected from the group consisting of:
a configuration parameter upgrade, a configuration parameter change, a firmware upgrade, a software upgrade, and supplemental data upgrade.

7. The computer usable medium of claim 5, wherein the imaging device command is selected from the group consisting of:
job processing commands, and imaging device action requests.

8. The computer usable medium of claim 5, wherein the data request is selected from the group consisting of:
usage information, status information, device information, device capability inquiries, device configuration parameters, device firmware, device supplemental data, example forms, XML data, HTML data, text data, text forms, binary data, encoded binary data, and Email attachments.

9. A method of operating an imaging device, the method comprising:
receiving an Email message at an imaging device; and
processing the Email message on the imaging device, wherein the Email message is selected from the group consisting of a configuration update, a data request, and an imaging device command.

10. A method of operating an imaging device system having a plurality of imaging devices, the method comprising:
composing an Email message;
sending an Email message to at least one imaging device of the plurality of imaging devices;
relaying the Email message through a relay device to a receiving imaging device; and
interpreting the Email message on the at least one imaging device, wherein the Email message is selected from the group consisting of a configuration update, a data request, and an imaging device command.

11. The method of claim 10, wherein sending an Email message to at least one imaging device of the plurality of imaging devices further comprises sending an Email message to at least one imaging device of the plurality of imaging devices that is local or to at least one imaging device of the plurality of imaging devices that is remote.

12. The method of claim 10, wherein sending the Email message further comprises sending the Email message with an origination process selected from the group consisting of manual origination process, polled origination process, chronological origination process, and event-driven origination process.

13. The method of claim 10, wherein sending an Email message to at least one imaging device of the plurality of imaging devices further comprises sending an Email message to at least one imaging device of the plurality of imaging devices where the originator is selected from the group consisting of a sending imaging device, a user, an administrator, a program, a server, a driver, and a master device.

14. The method of claim 13, wherein the master device maintains an internal list of addresses of receiving imaging devices.

15. The method of claim 10, wherein the relay device is a master device.

16. The method of claim 15 wherein the master device translates the Email message to another communication protocol prior to relaying.

17. The method of claim 13, wherein the relay device is a local master imaging device on a remote network.

18. A system comprising:
at least one relay device; and
a plurality of imaging devices, wherein at least one imaging device of the plurality of imaging devices comprises:
a network interface; and
an Email processing system, wherein the Email processing system of the imaging device can communicate via Email through the network interface to the at least one relay device, and where the Email processing system is adapted to process Email messages that are selected from the group consisting of a configuration update, a data request, and an imaging device command.

19. The system of claim 18, wherein the at least one imaging device of the plurality of imaging devices is on a local network or is on a remote network.

20. The system of claim 18, wherein the at least one imaging device communicates via Email messages with an origination process selected from the group consisting of manual origination process, polled origination process, chronological origination process, and event-driven origination process.

21. The system of claim 18, wherein the at least one imaging device communicates via Email messages with an Email originator that is selected from the group consisting of a sending imaging device, a user, an administrator, a program, a server, a driver, and a master device.

22. The system of claim 21, wherein the master device maintains an internal list of addresses of receiving imaging devices.

23. The system of claim 18, wherein the relay device is a master device.

24. The system of claim 23 wherein the master device translates the Email message to another communication protocol.

25. The system of claim 21, wherein the relay device is a local master imaging device on a remote network.
